(19) United States
(12) Patent Application Publication
(10) Pub. No.: US 2007/0283580 A1
(43) Pub. Date: Dec. 13, 2007

(54) Guide device for pneumatic saw

(76) Inventor: Yu-Fu Hsieh, Taipei (TW)

Correspondence Address: TROXELL LAW OFFICE PLLC;Suite 1404, 5205 Leesburg Pike, Falls Church, VA, 22041, US

(21) Appl. No.: 11/450,468

(22) Filed: Jun. 12, 2006

(51) Int. Cl. B23D 49/00

(52) U.S. Cl. 30/392; 30/289

(57) ABSTRACT

A guide device for pneumatic saw comprises a fixed member at the front end of th epneumatic saw; the fixed member has a recess channel, in which a fastening plate is mounted by means of screws; the front end of the fastening plate is furnished with a U-shaped plate; the U-shaped plate is furnished with two side plates, between which a gudie wheel with a shaft is mounted; both ends of the shaft are mounted in two round holes in the two side plates respectively; the guide wheel mounted in the U-shaped plate has a wheel groove to be in contact with the flat surface of the saw blade so as to provide the saw blade with a guide and fulcrum effect during the saw blade moving back and forth.

### BACKGROUND OF THE INVENTION

1. Field of the Invention

This invention relates to a pneumatic saw, and particularly to a pneumatic saw furnished with a guide device at the front end thereof.

2. Description of the Prior Art

In a conventional pneumatic saw, the sawing machine usually comprises a body portion and a fixed member; the lower part of the fixed member is furnished with a guard lid and a guard bar at the front end of the guard lid; as soon as the transmission shaft is moving back and forth, the saw blade will provide cutting operation.

In the conventional pneumatic saw, the chuck cylinder will bear all cutting pressure; as a result, the chuck part of the chuck cylinder is subject to an over pressure to cause the saw blade to became loose or to separate from the chuck.

### SUMMARY OF THE INVENTION

The prime object of the present invention is to provide a pneumatic saw with a guide device; the front end of the body portion of the pneumatic saw is furnished with a guide wheel at the front end of a fixed member; when the saw blade moves back and forth to cut a work, the guide wheel will be in contact with the flat surface of the saw blade so as to provide the saw blade with a guide and fulcrum effect.

A further object of the present invention is to provide the pneumatic saw with a guide device; the fixed member has a recess channel mounted with a fastening plate, which is fastened to the fixed member with a plurality of screws without affecting the chuck cylinder to move.

A still further object of the present invention is to provde the pneumatic saw with a guide device; the recess channel of the fixed member is mounted with a fastening plate, of which the front end is furnished with a U-shaped plate having two side plates; a shaft is mounted between the two side plates; the shaft is mounted through a shaft hole in the guide wheel so as to have the guide wheel pivotally mounted between the two side plates as a guide device.

Another object of the present invention is to provide the pneumatic saw with a guide device, in which the guide wheel is furnished with a wheel groove to be in contact with the flat surface of the saw blade so as to provide the saw blade with a guide and fulcrum effect upon the saw blade moving back and forth.

### BRIEF DESCRIPTION OF THE DRAWINGS

FIG. 1 is a plan view of a pneumatic saw of the present invention.

FIG. 2. is a perspective view of the present invention, showing the front structure of the pneumatic saw.

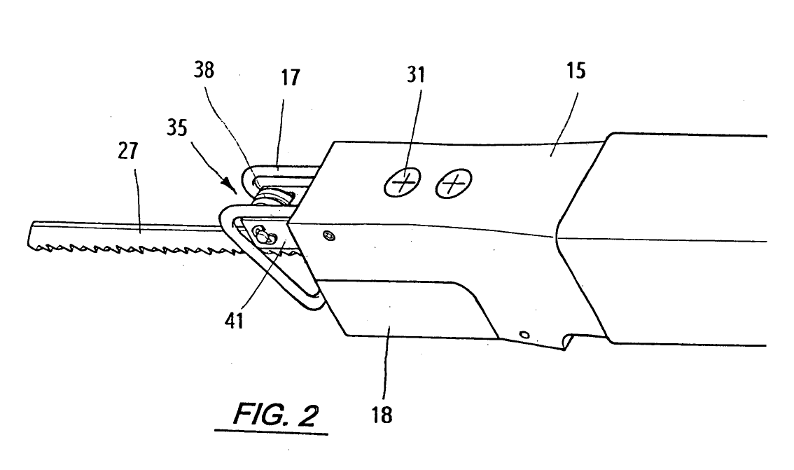

FIG. 3 is a perspective view of the present invention, showing the back structure of the pneumatic saw.

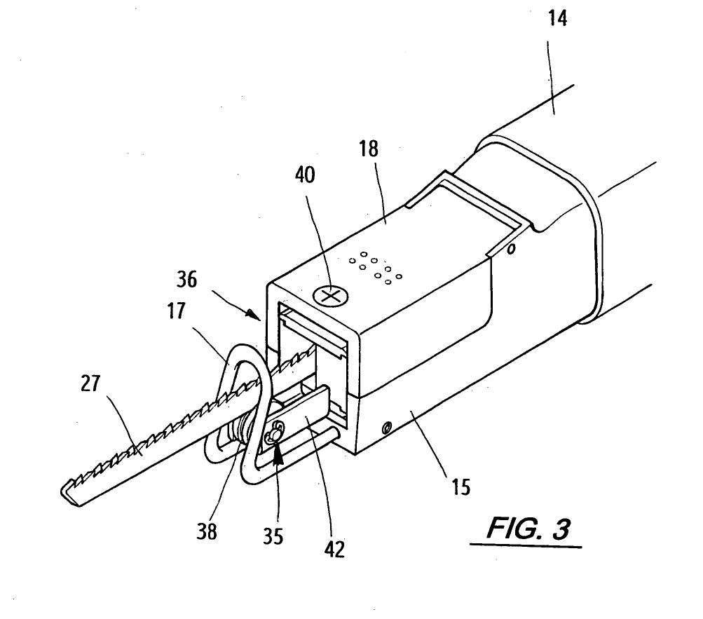

FIG. 4 is a disassembled view of the present invention, showing the assembly structure on the front end of the pneumatic saw.

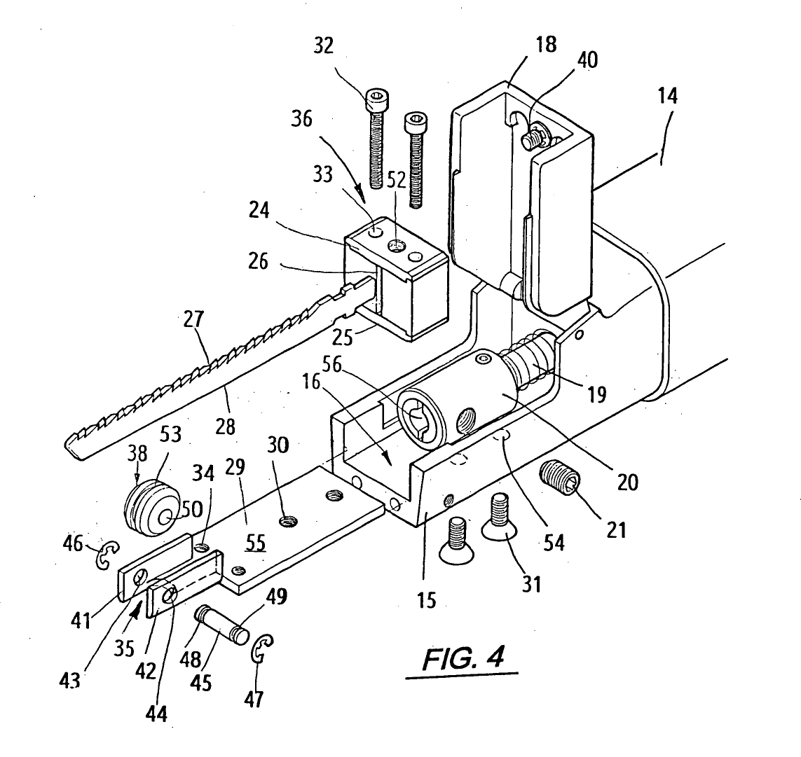

FIG. 5 is a sectional view of the present invention, showing a fulcrum structure on the front end of the pneumatic saw.

### DETAILED DESCRIPTION OF THE PREFERRED EMBODIMENT

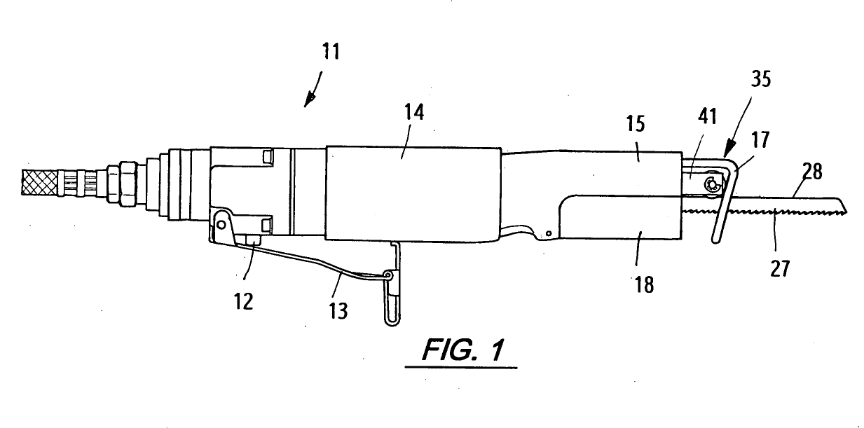

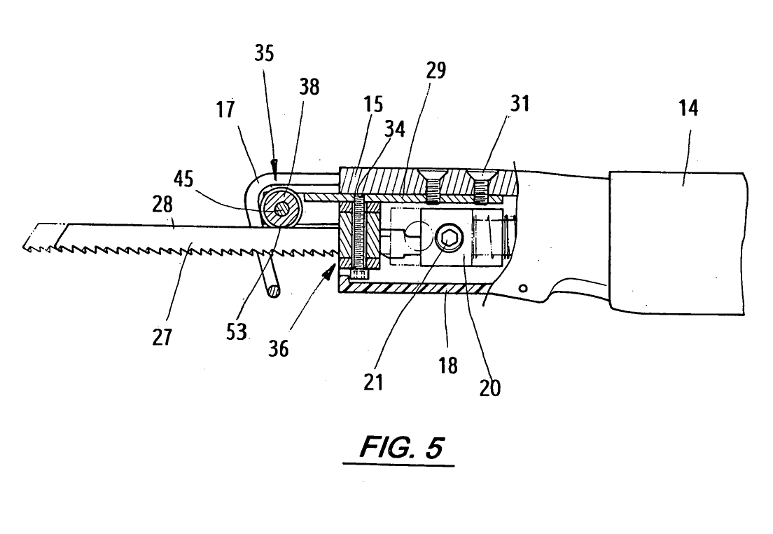

This invention relates to a guide structure for the front end of a pneumatic saw; as shown in FIGS. 1 and 5, the pneumatic saw 11 has a valve 12 on the rear end of the body portion 14. The valve 12 has a cock 13 to control pressure air to enter. The inside of the body portion 14 is furnished with a piston connected with a transmission shaft 19 so as to have a power transmitted to a front chuck cylinder 20, of which the front end is plugged with a saw blade 27; the chuck cylinder 20 is mounted with a stop screw 21 at one side thereof so as to have the saw blade 27 fastened in the chuck cylinder 20. The piston can be moved back and forth to have the saw blade 27 cut back and forth.

The front end of the body portion 14 of the pneumatic saw 11 is furnished with a fixed member 15, of which the outer side has a recess channel 16 hinged with a guard lid 18 so as to form into a covered protection member. The inside of the fixed member 15 is mounted with a piston connected with a transmission shaft 19; the transmission shaft 19 is pivotally connected with a chuck cylinder 20. Between the chuck cylinder 20 and the recess channel 16, there is a small space for mounting a fastening plate 29; the fastening plate 29 is furnished with symmetrical screw holes 30, which are corresponding with the sunk screw holes 54 in the recess channel 16. After the plate sueface 55 of the fastening plate 29 is closely mounted on the recess channel 16 of the fixed member 15, the fastening plate 29 will be fastened in place with screws 31.

The fastening plate 29 mounted in the recess channel 16 of the fixed member 15 has two screw holes 34 at the outer end thereof to facilitate a saw guide assembly 36 to be mounted in place with screws 32 through two cylindrical holes 33 respectively. The saw guide assembly 36 has two guide block 22 and 23, and a gap 26 is furnished between the two guide blocks 22; bothe the upper and lower sides of the two guide blocks 22 and 23 are mounted in place with an upper fastening plate 24 and a lower fastening plate 25; the gap 26 has a suitable width to enable a saw blade 27 to pass through; then, the end of the saw is plugged into the slot of the chuck cylinder 20; one side of the saw end is fastened in place with a stop screw 21. After the saw balde 27 is mounted to the chuck cylinder 20, the saw blade 27 can be moved back and forth within the gap 26 of the saw guide assemby 36 along a limited guide.

In order to furnished a proper safety for the chuck cylinder 20, the inner end of the fixed member 15 is mounted pivotally with a guard lid 18; the guard lid 18 is designed to cover the corresponding recess channel 16, and is fastened in place with a screw 40; in other words, the parts in the guard lid can be protected properly; further, the front end of the fixed member 15 is furnished with two symmetrical cylindrical holes for mounting two guard bars 17 so as to protect the front end of the fixed member 15.

In order to reduce pressure upon the saw blade 27 moving back and forth, the outer end of the fastening plate 29 is furnished with a U-shaped plate 35 having two symmetrical side plates 41 and 42 by means of punch method; there is a small space between the two side plates 41 and 42 for mounting a guide wheel 38 therein.

Both front ends of the two side plates 41 and 42 are furnished with two symmetrical round holes 43 and 44 respectively for mounting a shaft 45 with a guide wheel 38 therein through a shaft hole 50; both ends of the shaft 45 are furnished with two retaining-ring grooves 48 and 49 respectively; after the guide wheel 38 on the shaft 45 is mounted between the two side plates 41 and 42, two retaining rings 46 and 47 are mounted in the two retaining-ring grooves respectively so as to fasten the guide wheel 38 in place.

The guide wheel 38 in the U-shaped plate 35 at the front end of the fastening plate 29 has a suitable diameter and a shaft hole 50 to fit for the diameter of the shaft 45; the shaft 45 is mounted pivotally between the two side plates 41 and 42 of the U-shaped plate 35. The guide wheel 35 has a wheel groove 53 with a suitable width and depth so as to have the flat surface 28 of the saw blade 27 fitted therein after the saw blade 27 is plugged in the plug-in groove 56 of the chuck cylinder 20, and is fastened in place with a stop screw 21; in that case, the guide wheel 38 in the front end of the fixed member 15 would provide the saw blade with a fulcrum and guide effect upon the saw blade 27 moving back and forth.

The guide wheel 38 at the front end of the fixed member 15 is pivotally mounted in the U-shaped plate 35 with a shaft 45. The U-shaped plate 35 is punched in shape at one end of the fastening plate 29. The plate surface 55 of the fastening plate 29 is flatly mounted in the recess channel 16 and under the lower fastening plate 25, and then is fastened in place with screws 31. The fastening plate 29 and the U-shaped plate 35 would not hinder the chuck cylinder 20 to move; the fastening plate 29 and the U-shaped plate 35 are fastened to the recess channel 16 of the fixed member 15; the outer end of the plate surface 55 of the fastening plate 29 and the saw guide assembly 36 are mounted in place by menas of screws 31 and 32 to plug through cylindrical holes 33 and screw holes 34 in the fastening plate 29; in other words, the saw guide assembly 36 is to be fastened in the recess channel 16 of the fixed member 15 and on the plate surface 55 at the front end of the fastening plate 29.

The saw guide assembly 36 is mounted between the chuck cylinder 20 and the guide wheel 38; when the pneumatic saw 11 is operated, the chuck cylinder 20 moves back and forth in a space of the fixed member 15 so as to have the saw blade 27 moved back and forth; in that case, the saw blade 27 will be guided and limited by means of the gap 26 of the saw guide assembly 36 to prevent it from bias movement. The U-shaped plate 35 at the front end of the saw guide assembly 36 is pivotally mounted with a guide wheel 38 by means of a shaft 45; the flat surface 278 of the saw blade 27 is in contact with the wheel groove 53 of the guide wheel 38; when the saw blade 27 is driven to move back and forth by the chuck cylinder 20, the guide wheeel 38 will turn simultaneously; further, when a pressure is applied to the saw blade 27, the flat surface 28 of the saw blade 27 will have a fulcrum so as to provide the pneumatic saw 11 with more force exerted in cutting operation.

While the invention has been described with reference to specific embodiments it must be understood that those embodiments are susceptible to many changes, substitutions, and modifications that will be readily apparent to those having ordinary skill in the art without departing from the scope and spirit of the invention.

What is claimed is:

1. A guide device for the front end of a pneumatic saw comprising a body portion, a fixed member mounted at front end of said body portion, a recess channel mounted in said fixed member; said recess channel including a transmission shaft and a chuck cylinder; said chuck cylinder covered with a guard lid, and said recess channel mounted with a fastening plate, and features of said guide device is described as follows:
front end of the said pneumatic saw mounted with said fixed member having a recess channel, and in said recess channel, a fastening plate is mounted flatly in place with screws; front end of said fixed member furnished with a U-shaped plate, and a guide wheel mounted between two side plates of said U-shaped plate, and a guide wheel mounted between two side plates of said U-shaped plate; center of said guide wheel having a shaft hole for receiving a shaft; both ends of said shaft mounted pivotally in round holes of said two side plates respectively; edge of said guide wheel furnished with a wheel groove to be in contact with a flat surface of a saw blade, and during said saw blade being operated under a pressure, said guide wheel can provide said saw blade with a guide and fulcrum effect.
